(19) United States
(12) Patent Application Publication
(10) Pub. No.: US 2009/0064326 A1
(43) Pub. Date: Mar. 5, 2009

(54) METHOD AND A SYSTEM FOR ADVANCED CONTENT SECURITY IN COMPUTER NETWORKS

(75) Inventor: LEONID GOLDSTEIN, Costa Mesa, CA (US)

Correspondence Address: DLA PIPER US LLP, 1999 AVENUE OF THE STARS, SUITE 400, LOS ANGELES, CA, 90067-6023, US

(73) Assignee: GTB TECHNOLOGIES, NEWPORT BEACH, CA (US)

(21) Appl. No.: 11/850,273

(22) Filed: Sep. 5, 2007

(51) Int. Cl. G06F 11/30

(52) U.S. Cl. 726/22

(57) ABSTRACT

The present invention relates to a method and a system for protecting data in a computer network. A device is placed on a network edge in such a way, that all outgoing data has to pass through it. Separately, a set of data that is not allowed to leave the network is defined and stored in a secure form (typically, one way hash). The device determines the network protocol, file type, transforms and normalizes the passing data, and seeks the presence of the data from the defined set. If a threshold amount of the protected data is present, the device takes one of the following actions: block, alert, log, redact, store, redirect, encrypt, notify sender.

### BACKGROUND OF THE INVENTION

1. Field of the Invention

The present invention relates to the field of the computer network security.

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all rights whatsoever.

2. Background Art

Security is an important concern in computer networks. Networks are protected from illegal entry via security measures such as firewalls, passwords, dongles, physical keys, isolation, biometrics, and other measures. FIG. 1 illustrates an example of prior art security in a network configuration. A Protective Device 102 resides between an Internal Network 101 and an Outside Network 103. There are multiple methods of protection, designed to protect the inside network (or a single computer) from the entering of harmful data from the outside network. In other words, these techniques seek to prevent the outside from getting into the network. One prior art security device is a content filtering device. It works by cataloguing allowed and banned URLs, web sites, web domains. It may also perform a real time scan for forbidden words or through active blocking of certain IP addresses and ports. Another prior art technique is a network edge anti virus device. The example of FIG. 1 is typical of prior art security schemes in that it is principally designed to limit entry to the network. However, there are fewer methods to prevent exits from a protected network in the form of data leaks. This is unfortunate, because a significant threat in networking is the leaking of confidential materials out of the network.

One method of leak protection includes recognizing predefined keywords in the outbound data. The list of keywords is frequently entered manually. A security breach is determined when a particular combination of keywords is encountered in the outbound data. For example, a company, fearing leaks of its financial data, may enter keywords “revenue”, “profit”, “debt” etc. This method suffers from a high level of false positives.

Another possible method is recognizing simple patterns, such as a 16-digit credit card numbers. When such identifiers are recognized and when such outbound data has not been authorized, the data transmission may be stopped. This method also suffers from a high level of false positives.

One may think that it is possible to improve the method above by comparing with actual data (i.e. actual credit card numbers in the example above), but storing actual sensitive data in the proximity of the network edge constitutes unacceptable risk in itself. Also, such a system would not scale very well.

A separate problem, not addressed in the prior art, is data converted from plain text (ASCII) into different file formats or compressed.

Another problem is that there are no advanced means of reacting to the detected security breach, such as redacting away the confidential data.

These prior art methods are inadequate for the task of providing security against data leakage.

### SUMMARY OF THE INVENTION

The present invention relates to a method and a system for protecting data in a computer network. More specifically, it protects against intentional and unintentional leakage of confidential data.

In one embodiment, it is a system for controlling data transfer in a network comprising:

an inspection device coupled to said network to monitor network transmissions in said network, a data storage, coupled to said inspection device, said inspection device comprising:

at least one network interface card,

data comparison means,

means for deciding on security breach,

at least one of the following: means for alerting security personnel, means for logging security breaches, means for stopping data stream with the security breach, means for redacting data stream with the security breach, means for encrypting data stream with the security breach, means for re-directing the data stream with the security breach, means for storing the data stream with the security breach, means for releasing the previously stored data stream with the security breach.

Further, the system can be connected to the network inline (as a network bridge or a router), out of line (via a tap, a switch or a hub), or as a Mail Transfer Agent (hereinafter MTA). The system, connected as an MTA, will work only with email, but may be physically deployed outside of the protected network.

A set of data that is not allowed to leave the network is defined and stored in a secure form (typically, one way hash or fingerprints, but another derivative of the original data may be used). Also, the rules are defined. The device can optionally detect the network protocol, parse known protocols, detect file boundaries and types, convert files or extract text data and “normalize” the data. Then it seeks the presence of the data from the defined set. If a threshold amount of the protected data is present, the device interrupts the connection or takes other appropriate action. Protected data may be structured or unstructured. The system may decrypt data that needs to be inspected.

Disclosed also a method of controlling data transfer in a network comprising:

identifying certain data in said network as protected data;
monitoring attempts to transmit data out of said network;
detecting network protocol, in which data is being transmitted;
comparing data to be transmitted out of said network to said protected data;
indicating a security breach when at least a threshold level of said data to be transmitted matches data in said protected data.

The method can optionally include: detecting the network protocol, parsing known protocols, detecting file boundaries and types, converting the files or extracting text data and “normalizing” the data.

### BRIEF DESCRIPTION OF THE DRAWING

FIG. 1 illustrates a prior art network system.

FIG. 2 illustrates an inline embodiment of the system according to the invention.

FIG. 3 illustrates an out of line embodiment of the system according to the invention.

FIG. 4 illustrates an MTA embodiment of the system according to the invention.

FIG. 5 illustrates an embodiment of the Inspection Device according to the invention.

FIG. 6 illustrates a structured data comparison subsystem according to the invention.

FIG. 7 illustrates an action subsystem according to the invention.

FIG. 9 is a flow diagram illustrating the operation of an Inspection Device according to the invention.

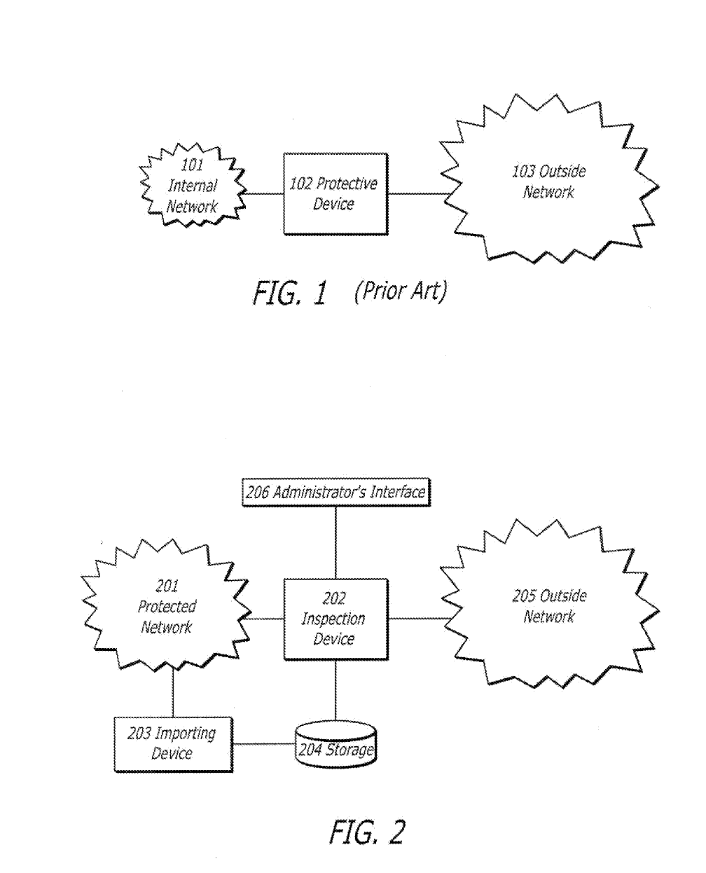

### DETAILED DESCRIPTION OF THE INVENTION

In the following description, numerous specific details are set forth to provide a more thorough description of embodiments of the invention. It is apparent, however, to one skilled in the art, that the invention may be practiced without these specific details. In other instances, well known features have not been described in detail so as not to obscure the invention.

FIG. 2 illustrates an inline network configuration according to the invention. An Inspection Device 202 is connected to a Protected Network 201 in such a way that all the outbound traffic from the Protected Network 201 to the Outside Network 205 passes through it. An Importing Device 203 is connected to the Protected Network 201 as well, and a Storage Device 204 is set up in such a way that it is connected to both Inspection Device 202 and Importing Device 203.

In one embodiment, Inspection Device 202 is connected as a network bridge. To increase reliability, Inspection Device 202 should be equipped with a so called ‘by pass circuit’. The by pass circuit becomes directly connected (as a simple wire), when the device is shut down, or when the software detects a problem and gives an order to go into the direct mode. In another embodiment, Inspection Device 202 is connected as a router. It can be built to connect as either bridge or router, depending on the user's choice.

The Inspection Device 202 typically comprises a computer or other networking device, with a CPU, RAM, a hard drive and networking means. Nevertheless, the Inspection Device 202 may comprise multiple physical devices.

The Importing Device 203 may comprise a stand alone computer or other networking device with a CPU, RAM and an optional hard drive. The Importing Device 203 and the Inspection Device 202 may be combined into one physical device.

Storage Device 204 may be a stand alone device in the network or be combined with the Inspection Device 202 and/or the Importing Device 203. The Storage Device 204 may comprise a relational database, such as MySQL or Oracle, or a database cluster. In one embodiment, the Storage Device 204 is combined with the Inspection Device 202. A single Storage device 204 can be connected to multiple Importing Devices 203 and/or multiple Inspection Devices 202. Also, multiple Storage Devices 204 can be connected to a single Importing Device 203 and/or Inspection Device 202. An Administrator's Interface 206 is optionally connected to the Inspection Device 202 for the purpose of monitoring and managing it and viewing the logs.

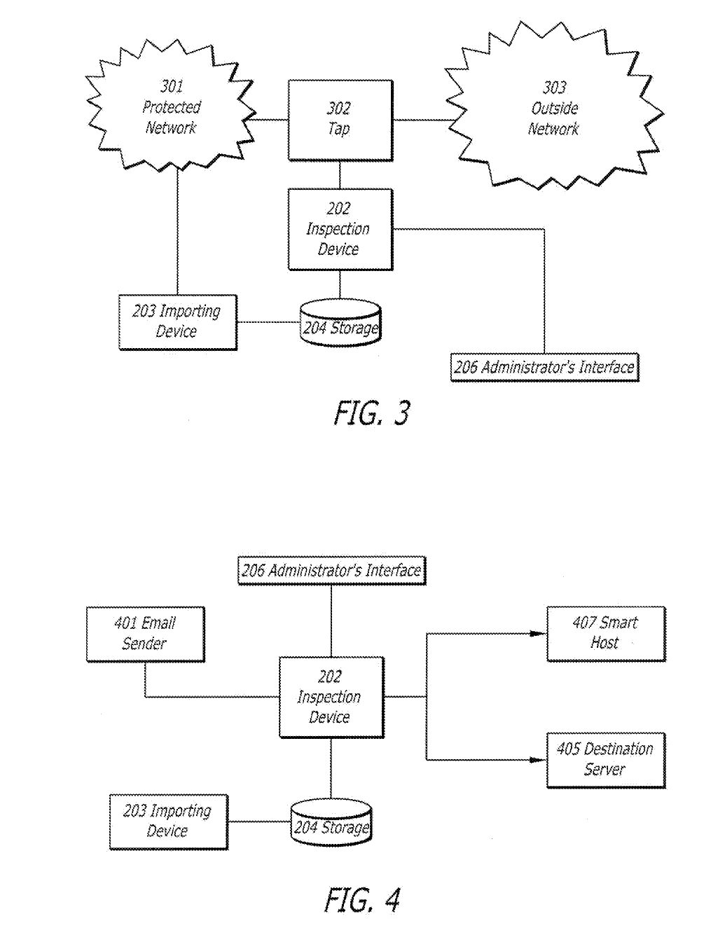

FIG. 3 shows an embodiment with out of line deployment. The Inspection Device 202 is connected to a tap 302, sitting between the Protected Network 301 and the Outside Network 303. An Importing Device 203 is connected to the Protected Network 201 as well, and a Storage Device 204 is set up in such a way that it is connected to both Inspection Device 202 and Importing Device 203. An Administrator's Interface 206 is optionally connected to the Inspection Device 202 for the purpose of monitoring and managing it and viewing the logs.

In another embodiment, a network switch with a span or mirror port can be used instead of the tap 302. In a low performance network, a hub may be used instead of the tap 302 as well.

In one embodiment, the system allows both inline and out of line deployment.

The “Outside Network” means the network into which the data is being sent. In many cases, it is the “Internet”, and the internal network of the company or an organization is the protected network. Nevertheless, the Inspection Device 202 may be set up to monitor data transfer between two segments of the internal network. In the out of line mode, it can be set up to monitor data transfer between the computers on the same network segment. An important special case of the Outside Network 205 or 303 is a printer or a printing server.

FIG. 4 shows an embodiment with MTA deployment. In it an Email Sender 401 sends emails through the Inspection Device 202 acting as MTA (or comprising MTA). A Storage Device 204 is set up in such a way that it is connected to both Inspection Device 202 and Importing Device 203. An Administrator's Interface 206 is optionally connected to the Inspection Device 202 for the purpose of monitoring and managing it. Inspection Device 202 is configured to forward the emails to either Destination Server 405 or Smart Host 407.

Email Sender 401 can be either an SMTP server (for example, Microsoft Exchange, IBM/Lotus Domino), or an SMTP client, such as Microsoft Outlook or Outlook Express. In this embodiment, Email Sender 401 must be specifically configured to send at least some of its emails to Inspection Device 202. For example, in the Outlook configuration, the field “SMTP Server” should be set to the address of the Inspection Device 202.

It should be noted, that the Inspection Device 202 inspects only emails in this embodiment, typically using SMTP protocol. Inspection Device 202 can be constructed to allow the MTA deployment simultaneously with either inline or out of line deployment.

Inspection Device Description

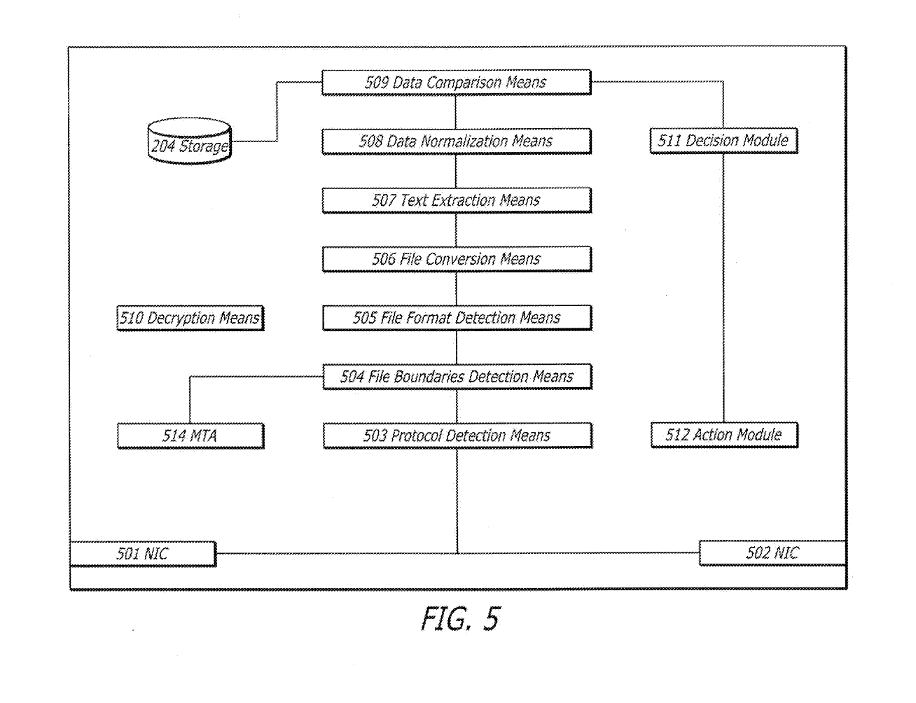

To perform its functions, the Inspection Device 202 comprises the following elements (see FIG. 5):

Network Interface Card (NIC) 501 and an optional Network Interface Card (NIC) 502 (possibly on one physical card). In the inline mode, NIC 501 is connected to the network in the “inside” direction and NIC 502 is connected to the network in the “outside” direction, and there may be another, third NIC, for the Administrator's interface. In the out of line mode, NIC 501 is connected to the tap. In the MTA mode, NIC 501 is connected to a switch. Then, there is a stack of the software modules for analysis and ultimate data extraction, comprising:

Protocol Detection Means (PDM) 503

File Boundaries Detection Means (FBDM) 504

File Format Detection Means (FFDM) 505

File Conversion Means (FCM) 506

Text Extraction Means (TEM) 507

Data Normalization Means (DNM) 508

Data Comparison Means (DCM) 509;

Additionally, there are Decryption Means 510, Decision Module 511 and Action Module 512. FIG. 3 shows Data Storage 512, which belongs to the Storage Device 204, which is combined with the Inspection Device 202 in the described embodiment.

Decryption Means 510 and the stack elements 503-508 are optional. PDM 503 is not used in the MTA mode, because the protocol is already known (typically SMTP.) Instead, MTA module 514 (such as a well known software package Exim) is used.

Protocol Detection Means 503 detects the network protocols (SMTP, HTTP, Jabber, SSL etc.), typically by analysing the content of the first few packets. The descriptions of the protocols are widely available. For example, HTTP is described in RFC 2616. It is preferred method, compared with detecting the protocol, based on the well known port (such as port 80 for HTTP). The port can be configured differently, and there are applications that can intentionally use the well known port for another protocol in order to evade detection. If PDM 503 cannot detect the protocol, the data is considered as belonging to “unknown protocol”.

File Boundaries Detection Means 504 finds beginnings (and, optionally, ends) of the transferred files. File Format Detection Means 505 uses this information in order to detect the file type and format (Word, Excel, GIF, ZIP etc.), typically based on the well known signatures in the beginning of the file. Then, File Conversion Means 506 may be invoked to convert the file to a format more convenient for analysis. For example, a ZIP file may be unzipped in order to enable uncompressed data comparison. Another type of conversion is language encoding conversion. For example, ASCII encoding is converted to UNICODE in order to always compare text in UNICODE format. Text Extraction Means 507 extracts the text from a file of any type.

The Decryption Means 510 are designed to decrypt a) encrypted network protocols; b) encrypted files. The Decryption Means 510 for network protocols works by importing one or more security certificates containing the private key; reading network packets exchanged by the server and the client through the Inspection Device 202; extracting the public key(s) from those packets; using both the public and the private keys to decode the packets encoded with the public key; extracting a secondary key(s), if generated by the client and/or server; using the available keys to decode the traffic. After decoding the traffic, the output is sent back to PDM 503 or FBDM 504 for normal processing.

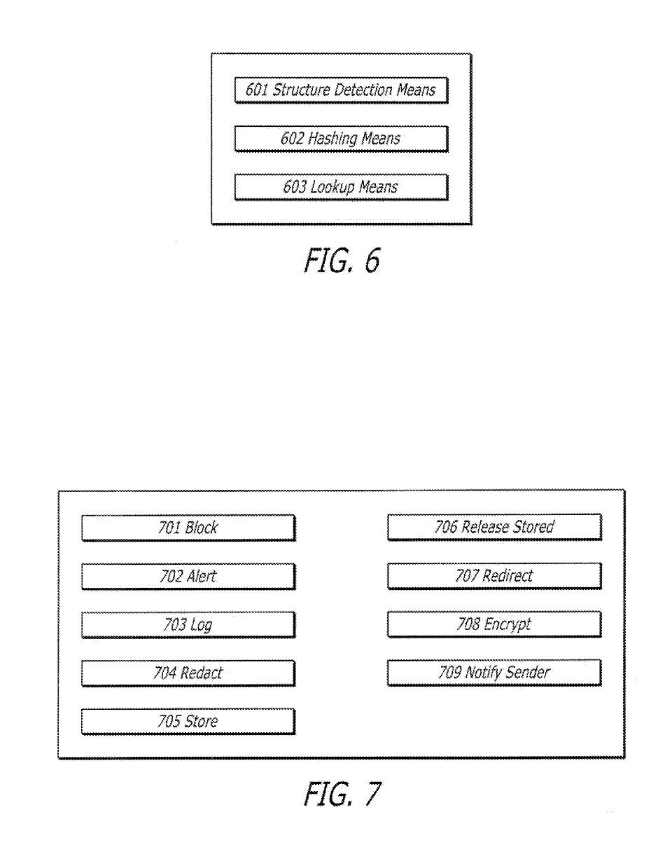

Referring to FIG. 6, in the embodiment, DCM 509 comprises Structure Detection Means 601, Hashing Means 602, Lookup Means 603 in the optional embodiment. Notice, that in some embodiments Structure Detection Means 601 are not present, and in some embodiments only Structure Detection Means 601 are present, and in some embodiments only Lookup Means 603 are present. The operation of these means in one embodiment is described below.

Data Normalization Means 510 allows the system to normalize, or bring into a canonical form, the data. For example, US phone numbers may be stored in any of the following forms: ‘(xxx) xxx xxxx’, ‘+1 xxx xxx xxxx’ or ‘xxxxxxxxxx’. After normalization, all of them are brought into a form ‘xxxxxxxxxx’. Normalization allows the system to bring the imported and inspected data to the same form.

Importing Device Operation

The function of the Importing Device 203 is to import some derivative of the data that needs to be protected, process it and to store the results of this processing in the Data Storage 204. In one embodiment of the invention the data being imported is structured data. By definition, structured data has structure, which can be used to find it in an arbitrary data stream. Examples of structured data: credit card numbers, social security numbers, phone numbers, bank account numbers, driver license numbers, names. Structure of the major credit cards, social security numbers, phone numbers, bank account numbers and certain state driver license numbers are well known. Names in English are tokens, consisting of letters, and mostly starting with a capital letter. Structured data is typically imported from databases, spreadsheets etc. On the request from an Administrator, the Importing Device 203 imports the data that needs protection into the Storage device 2004. This data is highly sensitive, and it will be hardly acceptable to make a copy of it outside of the original location, so the importing includes a step of one way hashing, performed on each element of data. The hashing is done using, for example, the MD5 algorithm, well known in the industry. If the data is normalized by the Inspection Device 202, it should be normalized by the Importing Device, too. Normalization is done prior to hashing on each record of the structured data. In another embodiment, the data is unstructured and consists of the text or binary data. For importing unstructured data, the Importing Device 203 may contain means for file format detection, conversion and text extraction, similar to those means, employed by the Inspection Device 202. Data normalization may comprise removal of non-ASCII or non-alphanumeric characters, converting upper case characters to lower case etc.

In one embodiment, it is possible to import another derivative of the data that needs protection (not just hases). For example, an index can be computed on the words and phrases, appearing in the original text. It is also possible to import the original data and to protect it with some sort of encryption. Nevertheless, both of these methods have issues from the security point of view, because of the risk of exposure to the original data. Another way to create and import derivatives of the data is to discover a pattern and to store one or more patterns in Storage 204. A typical way of describing patterns is via regular expressions (regex). Data description via patterns typically suffers from large amount of false positives, but may be convenient, when there is too much of the original data or its location is not known.

The Importing Device 203 may operate manually or automatically. In the automatic mode, the Importing Device 203 would import new database records and/or files when they change or being added (periodically or reactively to the event of the change). Each database record or file may carry additional attributes, such as secrecy level, IP addresses and protocols that control its ability to be exported, etc.

Inspection Device Operation

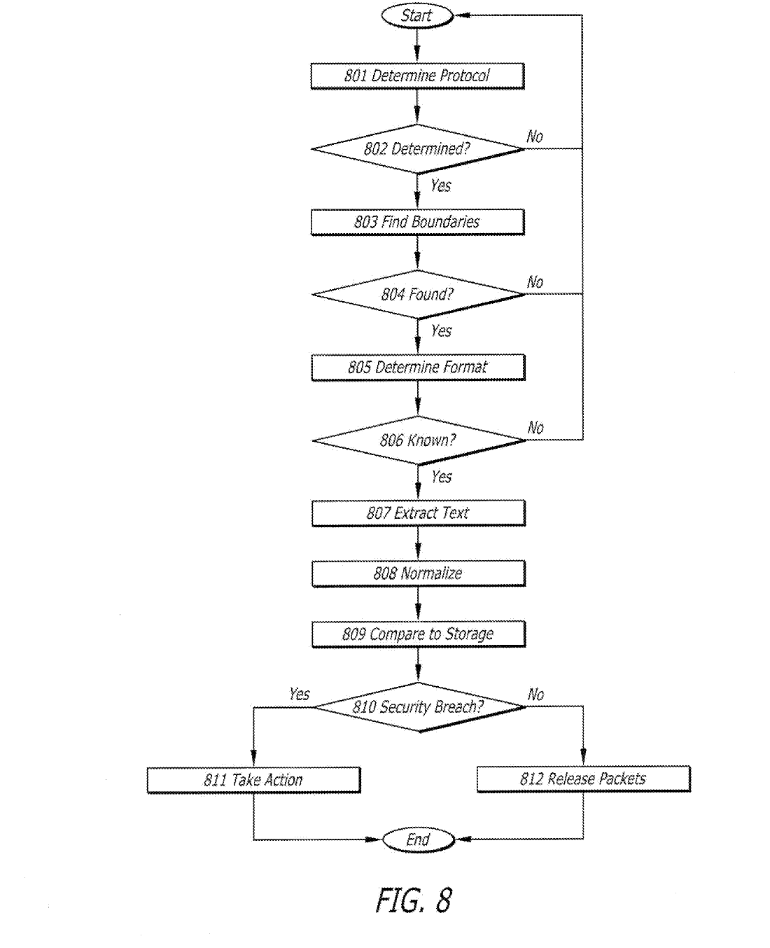

The function of the Inspection Device 202 is to monitor the outbound traffic for the presence of the protected data. It does that using the Data Storage 204. If the amount of the protected data being transferred in a stream exceeds a predetermined threshold (for example, a combination of social security and credit card numbers from the same record are transferred), a security breach (“violation”) is declared and a predefined action is taken by the Inspection Device 202. The possible actions by the Inspection Device 202 in different deployment types are shown in the FIG. 7 and summarized in the table below. More than one action can be taken in the same time.

| | Deployment | | |
|---|---|---|---|
| Action | Inline | Out of Line | MTA |
| Block 701 | X | X | X |
| Alert 702 | X | X | X |
| Log 703 | X | X | X |
| Redact 704 | X | — | X |
| Store 705 | X | X | X |
| Release Stored 706 | — | — | X |
| Redirect 707 | — | — | X |
| Encrypt 708 | X | — | X |
| Notify Sender 709 | X | X | X |

Block—prevents transmission of the violating data stream, and possibly similar data streams. Blocking in Inline and MTA modes is simple (just not delivering packets or emails, correspondingly), blocking in the out of line mode is achieved by sending RESET TCP packets to the both sides of the TCP connection.

Alert—sends an email or another type of communication to the security personnel

Log—logs the event of violation and its details, such as IP addresses of the source and destination, protocol, email addresses etc.

Redact—locates the violating data and replaces it with a repeating character, for example ‘XXXX’. TCP packets have a CFC checksum in the header, so the CFC checksum of the changed packets must be recomputed before releasing them.

Store—record the violating stream or email or its part on the hard drive for analyzing later.

Release Stored—release previously blocked and stored email after a review by a human. The ability to block, store and release the stored email after a human review allows implementing ‘quarantine’. In the quarantine, an email with the violation is not forwarded by MTA, but stored, and a human security is alerted. The human reviews the email in question, using the Administrator's interface 206. Then, he decides whether the violation is real or not. If there is no violation, the email is forwarded to the destination. If there is a real violation, the email can be redacted or encrypted and then forwarded, or it may be deleted outright.

Redirect—redirect an email with the violation through another MTA.

Encrypt—encrypt the data stream, containing the violation, including the protected data in that stream.

Notify Sender—notify the sender, who sent the protected data, of the violation. This action is usually taken together with some of the actions above.

If the threshold amount of the protected data is not detected, the Inspection Device 202 allows the inspected data to be sent to the Outside Network 205.

Ideally the Inspection Device 202 should recognize the protected data at any location in the data stream, even if the data was converted or modified. Thus, in the preferred embodiment, the Inspection Device 202 serves as a network bridge, where the data passing between the NIC 501 and NIC 502, is analyzed in real time. After receiving each packet, the following sequence of operations is performed (see FIG. 8):

If the packet belongs to a new TCP stream, or if the protocol is not determined yet, attempt to determine the protocol (step 801), using PDM 503. If not successful (check 802), wait for another packet. If no supported protocol fits, the stream is declared as UNKNOWN_PROTOCOL. If successful, try to find boundaries (the beginning and the end or at least the beginning) of data entities or files, carried by protocols (step 803), using FBDM 504. For example, SMTP (e-mail protocol), carries its body, and optionally attached files. If unsuccessful in determining beginning of the file (check 804), wait for more packets. If successful, try to determine the file format (step 805), using FFDM 505. In case of UNKNOWN_PROTOCOL, the beginning of the stream is considered as beginning of the file. If the file belongs to a known format (check 806), convert it to the preferred format, if possible. Preferred format is always uncompressed. Then, extract the text data in the ASCII form (step 807), using TEM 507. The methods of the text extraction depend on the specific data format. For example, for HTML files, he HTML tags should be removed. If the file format is unknown, leave it as it is. Finally, normalize output from the previous step (in step 808). Normalization brings data to some canonical form. Steps 801-807 are optional, and the steps 801-806 may fail, but the method will still work. Notice, that normalization here may be different from normalization, performed by Importing Device 203. Finally, compare the output of the previous step to the protected data in the Storage 204 (step 809), using DCM 509.

In one embodiment, the protected data comprises a set of hashes of structured data pieces, such as credit card numbers. In order to find out, whether the inspected data contains any of the protected data, perform the following steps on the inspected data: find the data with the correspondent structure. For example, in case of Visa or MasterCard numbers, consider sequences of 16 digits, starting with ‘4’ or ‘5’ and ending with a checksum. When such a sequence is detected, compute MD5 hash on it, and search in the Storage 204. In the embodiment, the Storage 204 is implemented via a database management system, and an SQL command can be used. It is important to use the prior knowledge of the structure of the data to its fullest, because a database query is an expensive operation and its use should be minimal. If a match is found, then there is an attempt to send the credit card number outside. In the check 810, the Decision Module 511 decides, whether a security breach has occurred. In the embodiment, each attempt to send outside protected data will be considered a security breach. In another embodiment, the system administrator will specify how many pieces of protected data are allowed out before the security breach is declared. Further, this threshold may differ depending on the identity of the sender, receiver or sending method. For example, a customer service rep will be allowed to send one credit card number to a partner, while the supervisor can send five numbers.

In another embodiment, the structure is defined by a set of the patterns, stored in the Storage 511, or pre-defined. In this embodiment, the decision is made after detecting the structure, without further inspection of the content. In another embodiment, there is no step of detecting structure. A lookup is performed on each piece of the structured data, found in the data stream, or on pre-defined chunks of the unstructured data. Other derivatives of the data may be used instead of hashing, provided they correspond to the derivatives, used by the Importing Device 203.

Finally, if there is a security breach, a command is issued to the Action Module 512 (step 811), and it blocks the data stream, sends an email to the Administrator and/or takes other actions. If there is no security breach, the packets corresponding to the inspected data are released (step 512). If the incoming data can not be inspected for some pre-defined time (1000 ms in embodiment), the packets are released anyway to prevent TCP stream disconnect.

The embodiment, described above, allows multiple modifications. The Storage 204 can be loaded to the RAM for faster access. A Bloom filter may be used to accelerate look ups in the Storage 204. Bloom filter is a well known mathematical construct. When using the Bloom filter, the suspected data match is quickly checked against Bloom array in the RAM. Only if there is a match, the final check against the Storage is performed.

1. A system for controlling data transfer in a network comprising:
an inspection device coupled to said network to monitor network transmissions in said network, a data storage, coupled to said inspection device, said inspection device comprising:
at least one network interface card,
data comparison means,
means for deciding on security breach,
at least one of the following: means for alerting security personnel, means for logging security breaches, means for blocking data stream with the security breach, means for redacting data stream with the security breach, means for encrypting data stream with the security breach, means for re-directing the data stream with the security breach, means for storing the data stream with the security breach, means for releasing the previously stored data stream with the security breach.

2. The system from claim 1, said data comparison means further comprising structure detection means.

3. The system from claim 2, said structure corresponds to at least one of the following: credit card number, bank account number, social security number, state driving license, phone number.

4. The system from claim 1, said data comparison means further comprising hashing means and data lookup means.

5. The system from claim 2, said data comparison means further comprising hashing means and data lookup means.

6. The system from claim 1, where said inspection device is attached as one of the following: a network bridge or a network router.

7. The system from claim 1, further comprising one of the following: a switch, a hub or a tap as means of the inspection device coupling to the network.

8. The system from claim 1, further comprising a Mail Transfer Agent.

9. The system from claim 1, further comprising network protocol detection means.

10. The system from claim 9, further comprising file boundaries detection means.

11. The system from claim 10, further comprising file type detection means.

12. The system from claim 11, further comprising text extraction means.

13. The system from claim 11, further comprising file conversion means.

14. The system from claim 9, further comprising data normalization means.

15. The system from claim 1, further comprising decryption means.

16. The system from claim 1, where at least one printer is coupled to said network as a data destination.

17. The system from claim 1, further comprising an importing device, coupled to said inspection device, said importing device importing some derivative of the protected data.

18. The system from claim 11, further comprising an importing device, coupled to said inspection device, said importing device importing some derivative of the protected data.

19. The system from claim 17, said importing device importing fingerprints of the protected data.

20. The system from claim 19, said importing device importing fingerprints of the protected data.

21. A method of controlling data transfer in a network comprising:
identifying certain data in said network as protected data;
monitoring attempts to transmit data out of said network;
detecting network protocol, in which data is being transmitted;
comparing data to be transmitted out of said network to said protected data;
indicating a security breach when at least a threshold level of said data to be transmitted matches data in said protected data.

22. The method from claim 21, further comprising a step of detecting the data structure.

23. The method from claim 21, further comprising a step of detecting at least one of the following data types: credit card number, bank account number, social security number, state driving license, phone number.

24. The method from claim 21, further comprising a step of alerting security personnel on a security breach occurrence.

25. The method from claim 21, further comprising a step of blocking the transmission, causing the security breach.

26. The method from claim 21, further comprising a step of determining files boundaries.

27. The method from claim 26, further comprising a step of determining file format.

28. The method from claim 27, further comprising a step of converting file format.

29. The method from claim 27, further comprising a step of extracting text from the data.

30. The method from claim 21, further comprising a step of computing at least one fingerprint on the data.

31. The method from claim 21, further comprising a step of decrypting encrypted data.
